(19) United States
(12) Patent Application Publication
(10) Pub. No.: US 2025/0277991 A1
(43) Pub. Date: Sep. 4, 2025

(54) DEVICES AND RELATED METHODS FOR TREATMENT OF BRAIN DISORDERS AND STIMULATING CHANGE IN PSYCHOLOGICAL STATE

(71) Applicant: Fredric Schiffer, Newton Highland, MA (US)

(72) Inventor: Fredric Schiffer, Newton Highland, MA (US)

(21) Appl. No.: 19/067,818

(22) Filed: Feb. 28, 2025

Related U.S. Application Data
(60) Provisional application No. 63/559,441, filed on Feb. 29, 2024.

(51) Int. Cl. G02C 7/10; G02C 7/08

(52) U.S. Cl. CPC G02C 7/104; G02C 7/086; G02C 7/108; G02C 2202/10

(57) ABSTRACT

The present invention is directed to novel devices and related methods of treating brain disorders. Such devices, include pairs of eyeglasses and clip-on accessories for a pair of eyeglasses constructed to asymmetrically integrate an occlusion eye lens component and a tinted eye lens component. In addition, the present invention provides methods of treatment utilizing these devices. These devices and methods offer lifestyle suitable solutions that may be incorporated seamlessly into daily life. Further, the devices of the present invention are capable of stimulating a change in the psychological state of the subject, for example to improve well-being, particularly in a manner that is lifestyle suitable.

### RELATED APPLICATIONS

This application is claims priority to U.S. Provisional Patent Application No. 63/559,441, filed on Feb. 29, 2024, the entirety of which is incorporated herein by reference.

### BACKGROUND OF THE INVENTION

Over the last couple decades, the theory that the brain is comprised of two hemispheres has been explored by several leading scientists, including Dr. Fredric Schiffer. In this respect, a number of existing split-brain studies have suggested that most people are of two minds, each associated with one brain hemisphere. One hemisphere is associated with an immature mind that may be affected by childhood traumas and is prone to self-destructive thoughts and feelings leading to diagnosable symptoms. The other hemisphere is much more resilient to the past traumas and functions at a much higher level. The healthier hemisphere is the right hemisphere in about 50% of patients, and this runs counter to the established notion that negative emotions are always associated with the right hemisphere.

Hundreds of millions of people world-wide suffer from brain disorders. Such disorders include psychiatric and neurologic disorders including, but not limited to disorders such as, depression, attention deficit disorder, schizophrenia, bipolar disorder, anxiety disorders, alcoholism, eating disorders such as anorexia and bulimia, phobias,

Asperser's syndrome, dissociative disorders, insomnia, Alzheimer's Disease, Parkinson's Disease, Autism, Stroke, and borderline personality disorder. These disorders are often chronic and require long-term treatment/therapy options that provide varying degrees of successful outcomes.

Anxiety disorders are the most prevalent illness in the United States with a prevalence of over 40 million adults, or about 18% of the population, each year. Anxiety disorders are often associated with depression, with persons suffering it being six times more likely to have a psychiatric hospitalization. Moreover, depression is the leading cause of disability world-wide, with an overall prevalence of almost 30% of populations studied having some sub-population having an incidence of over 50%. Sadly, depression not only causes profound suffering for the individual and their family, but also reduces social functioning and productivity and promotes other serious diseases, including diseases from cardiovascular to Alzheimer's Diseases, and is strongly associated with substance abuse and other mental illnesses as well as suicide. Moreover, drug abusing patients demonstrate mental distress, health complications, loss of productivity, and increased criminality, which are injurious not only to patients and their families, but also to society as a whole.

Furthermore, anxiety, depression, substance abuse, and post-traumatic stress disorders are often co-morbid, with the ultimate effect resulting in the need for reliable treatments that might account for all of these disorders simultaneously. Although treatment options exist (often addressing individual disorders alone), given the prevalence and often the life-long concerns of these disorders, new and advancing treatment options are highly desirable.

Convenience and comfort are two major factors in the success of treatments for brain disorders. As such, personal access to tools or devices that not only assist in treatment of brain disorders, such as depression or anxiety, but offer access to such therapy incorporated more seamlessly into daily life, i.e., lifestyle suitable, would offer daily convenient relief to patients and their families in a more comforting environment. Moreover, making it lifestyle suitable further helps reduce stigma of use and reduces self-consciousness of the person undergoing treatment.

As such, new methods of treating brain disorders are needed, along with new devices that are capable of implementing these methods. In particular, there is a need for devices and treatments that offer lifestyle suitable solutions that are incorporated seamlessly into daily life. Moreover, a need exists for tools/devices that can stimulate a change in the psychological state of the subject, for example to improve well-being, particularly in a manner that is lifestyle suitable.

### SUMMARY OF THE INVENTION

Accordingly, the present invention is directed to novel devices and related methods of treating brain disorders. Such devices, include pairs of eyeglasses and clip-on accessories for a pair of eyeglasses constructed to asymmetrically integrate an occlusion eye lens component and a tinted eye lens component. In addition, the present invention provides methods of treatment utilizing these devices. These devices and methods offer lifestyle suitable solutions that may be incorporated seamlessly into daily life. Further, the devices of the present invention are capable of stimulating a change in the psychological state of the subject, for example to improve well-being, particularly in a manner that is lifestyle suitable.

As such, one aspect of the present invention provides a clip-on accessory for a pair of eyeglasses comprising: a frame, constructed to asymmetrically integrate two eye lens components, incorporating a clip retainer that reversibly affixes the frame to a pair of eyeglasses of a wearer; an occlusion eye lens component integrated on one side of the frame designed and positioned for full occlusion of a first lateral retina of the first eye of the wearer, wherein the occlusion eye lens component is positioned from about the lateral-medial retina division line of the first eye of the wearer to about the inner corner of the eye of the wearer; and a tinted eye lens component integrated on the other side of the frame positioned for view by the entire retina of the second eye of the wearer, wherein the occlusion lens component and the tinted eye lens component are integrated asymmetrically in the frame.

Another aspect of the present invention provides a pair of eyeglasses comprising: an eyeglasses frame-front securing two lenses, wherein the frame-front is connected with a bridge and terminating in two temples, constructed to asymmetrically integrate an occlusion eye lens component and a tinted eye lens component; an occlusion eye lens component integrated on one side of the frame designed and positioned for full occlusion of a first lateral retina of the first eye of the wearer, wherein the occlusion eye lens component is positioned from about the lateral-medial retina division line of the first eye of the wearer to about the inner corner of the eye of the wearer; and a tinted eye lens component integrated on the other side of the frame positioned for view by the entire retina of the second eye of the wearer, wherein the occlusion lens component and the tinted eye lens component are integrated asymmetrically in the frame.

Another aspect of the present invention provides a method for treatment of a brain disorder characterized by neurologic or psychiatric disorder symptomology with a lateralized difference in hemispheric emotional valence, comprising: identifying a patient with a brain disorder; measuring a left hemispheric emotional valence for a left hemisphere of a brain of the patient and a right hemispheric emotional valence for a right hemisphere of the brain of the patient to identify a patient with a lateralized difference in hemispheric emotional valence; determining which hemisphere of the brain of the patient with a lateralized difference in hemispheric emotional valence has a more positive valence, and which hemisphere of the brain has a more negative valence; and applying to the patient a clip-on accessory for a pair of eyeglasses of the present invention or a pair of eyeglasses of the present invention, wherein the occlusion lens component is designed and positioned for full occlusion of the lateral retina associated with the hemisphere of the brain with the more negative valence combined with differential stimulation of the opposing retina, such that the brain disorder with lateralized difference in hemispheric emotional valence is treated in said patient.

Another aspect of the present invention provides a method for stimulating a change in the psychological state of a subject, comprising the steps of: determining which hemisphere of the brain of a subject with a lateralized difference in hemispheric emotional valence has a more positive valence and which has a more negative valence; applying to the subject a clip-on accessory for a pair of eyeglasses of the present invention or a pair of eyeglasses of the present invention, wherein the occlusion lens component is designed and positioned for full occlusion of the lateral retina associated with the hemisphere of the brain with the more negative valence combined with differential stimulation of the opposing retina; and such that the full occlusion of lateral retina associated with the hemisphere of the brain with the more negative valence combined with differential stimulation of the opposing retina provides favorable change in the psychological state of the subject.

### BRIEF DESCRIPTION OF THE FIGURES

Advantages of the present methods and related devices will be apparent from the following detailed description, which description should be considered in combination with the accompanying figures, which are not intended to limit the scope of the invention in any way.

FIG. 1 depicts a schematic diagram of the eyes, the retinas (i.e., lateral and medial), and how each contribute to the visual fields.

FIG. 2 is a front perspective view of one embodiment of the clip-on accessories for a pair of eyeglasses of the present invention, wherein the occlusion eye lens component would present on the left eye of the wearer.

FIG. 3 is a rear perspective view the clip-on accessory for a pair of eyeglasses depicted in FIG. 2.

FIG. 4 is a rear perspective view of one embodiment of the clip-on accessories for a pair of eyeglasses of the present invention, wherein the occlusion eye lens component would present on the right eye of the wearer.

FIG. 5 is a front perspective top down view of the clip-on accessory for a pair of eyeglasses depicted in FIG. 2, presented as clipped onto a pair of eyeglasses with temples open.

FIG. 6 is a front perspective view of the clip-on accessory for a pair of eyeglasses depicted in FIG. 2, presented as clipped onto a pair of eyeglasses with temples folded closed.

FIG. 7 is a rear perspective view of the clip-on accessory for a pair of eyeglasses depicted in FIG. 2, presented as clipped onto a pair of eyeglasses with temples open.

FIG. 8A) is a front perspective view of a wearer wearing a pair of eyeglasses of the present invention that is designed to invertible with the occlusion lens component shown on the left eye of the user formed as part of a lens that is equal in size to the tinted eye lens component where the area that is not the area of occlusion is tinted, shown with dimension examples; B) a front perspective view showing the eyeglasses of 8A with the wearers head at an angle turning to the right; and C) a front perspective view showing the eyeglasses of 8A alone and at angle to the right.

### DETAILED DESCRIPTION OF THE INVENTION

The present invention offers a tool for a novel method of lateral visual occlusion combined with differential stimulation of the opposing retina. In this respect, the tools/devices offered in the present invention utilize the newly identified optimal positioning of the occlusion component based on the lateral-medial retina division line ensuring full occlusion of the lateral retina of one eye, which is combined with differential stimulation of the opposing lateral retina.

The location of the occlusion component, and alternatively the visually accessible field defined by the lateral-medial retina division line, is critical for the treatment of brain disorders or improved stimulation of changes in psychological state; offering significant improvement over techniques that create peripheral rather than lateral visual field access and/or where the occlusion components are too small. Beyond that, offering combination differential stimulation of the opposing retina using a tinted lens affords a device that is not just therapeutic, but lifestyle conforming or suitable; wherein even though the lateral retina is fully occluded for one eye, the visual impact is negated by the brain compensating to show a complete image (i.e., a wearer does not notice the lateral retina is blocked). This affords a device that can be worn outside a designated treatment facility and while engaging in normal life activities. Moreover, in certain embodiments, including an occlusion component within a full sized lens with an occlusion area, and the non-occlusion area being tinted would be highly lifestyle suitable.

As such, the present invention is directed to novel devices and related methods of treating brain disorders. Such devices, include pairs of eyeglasses and clip-on accessories for a pair of eyeglasses constructed to asymmetrically integrate an occlusion eye lens component and a tinted eye lens component. In addition, the present invention provides methods of treatment utilizing these devices. These devices and methods offer lifestyle suitable solutions that may be incorporated seamlessly into daily life. Further, the devices of the present invention are capable of stimulating a change in the psychological state of the subject, for example to improve well-being, particularly in a manner that is lifestyle suitable.

The present invention, including devices and methods will be described with reference to the following definitions that, for convenience, are set forth below. Unless otherwise specified, the below terms used herein are defined as follows:

### I. Definitions

As used herein, the term “a,” “an,” “the” and similar terms used in the context of the present invention (especially in the context of the claims) are to be construed to cover both the singular and plural unless otherwise indicated herein or clearly contradicted by the context.

The term “about” is used herein in reference to the degree or extent of the term which it modifies, and that such extent may be 100% or near to but not exactly 100% of the modified term; industry accepted standards will assist in defining the quantitative aspects of how “near” 100% is defined. In particular embodiments, the term “about” indicates+3%, +2%, +1% or +0.5%. In a particular embodiment, for example, the language “positioned from about the lateral-medial retina division line of the first eye of the wearer” would be exactly from the lateral-medial retina division line. In an alternative particular embodiment, for example, the language “positioned from about the lateral-medial retina division line of the first eye of the wearer” would mean within +2% of the lateral-medial retina division line, e.g., in total distance.

The language “amalgamated lens” is a lens component that combines together multiple regions or areas in smooth transition as a single lens. For example, the occlusion eye lens component may, in certain embodiments, may comprise an occlusion area that serves the purpose of occlusion and is positioned from about the lateral-medial retina division line of the first eye of the wearer to about the inner corner of the eye of the wearer, but is part of a larger lens with an area that is not occluded (but rather is clear or tinted, e.g., to allow the medial retina to be uncovered.

The language “and/or” is used herein to mean both “and” in the conjunctive form and “or” in the disjunctive form.

The language “brain disorder” is art recognized and is used herein to describe a neurologic or a psychiatric disorder, i.e., characterized by symptomology of a neurologic or psychiatric disorder.

As used herein, the term “co-morbid” or “co-existent” refers to any psychiatric disorders that exist in addition to a primary disease or disorder, such as depression.

As used herein, the terms “depression,” “depressive disorder,” “dysthymic disorder,” “major depressive disorder” and “unipolar depression” refer to a DSM-IV definition of depression. In certain embodiments, depression may be defined as a combination of sadness, loss of energy, feelings of hopelessness, difficulty concentrating, insomnia, and irritability. The National Comorbidity Survey reported that 46% of men and 58% of women have suffered in their lifetime at least a two-week period in which they experienced a persistent depressed mood. Major depression has a lifetime prevalence of about 16%, and it is estimated that by 2020, it will be the second greatest contributor to the impairment of global health. A recent Australian survey reported that anxiety disorders were the most common mental disorder with a lifetime prevalence of 26%. Depression can run in families, and usually starts between the ages of 15 and 30. It is much more common in women. Women can also get postpartum depression after the birth of a baby. Some people get seasonal affective disorder in the winter. Depression is one part of bipolar disorder. Depression by any definition does not encompass most psychological disorders. For example, people who are diagnosed with schizophrenia have delusions and/or hallucinations and have a deterioration of their personality rendering them almost always incapable of complex work or sustained relationships. A person with an anxiety disorder will suffer excessive apprehension and worry with heightened arousal but will not feel sad or hopeless unless he/she suffers, in addition, a coexisting depressive disorder. A person who abuses substances will usually not also suffer anxiety or depression, although he may have a dual diagnosis in which both a substance abuse disorder and another disorder such as an anxiety disorder or a depressive disorder are also present. 47% of patients diagnosed with schizophrenia also have a substance abuse disorder.

Further, depression is associated with the integration of multiple intracellular signals that regulate neuronal response (i.e., changes in G protein, cyclic adenosine monophosphate, or protein kinase and the induction of gene transcription). These intracellular signals ultimately affect the expression of specific genes. It is these abnormalities of intracellular signal transduction and/or gene expression that underlie much of the physiology of depression. Other neurotransmitters (e.g., acetylcholine, gamma amino butyric acid, melatonin, glycine, histamine), hormones (e.g., thyroid and adrenal hormones), and neuropeptides (e.g., corticotropin-releasing hormone, endorphins, enkephalins, vasopressin, cholecystokinin, substance P) also play significant roles in the physiology of depression.

In depression, functional imaging studies most consistently demonstrate a decreased prefrontal cortex (PFC), especially left PFC, blood flow. These findings correlate with severity of illness and cognitive impairment. Functional imaging in depressed patients also show basal ganglia abnormalities, involving decreased blood flow and metabolism as well as increased activity of amygdala. In major depression, other neuroimaging studies show abnormalities in the hippocampus, cingulate, and related parts of the striatum and thalamus. Together, data offer a neural model for depression in which dysfunction of limbic, striatal, and PFC structures impair the modulation of the amygdala/hippocampus complex and lead to abnormal processing of emotional stimuli. Depression also tends to be associated with lesions in the left frontotemporal or right parieto-occipital regions.

The language “differential stimulation” is used herein to describe the use of tinted glasses that allow the simultaneous stimulation of the lateral retina of the positive hemisphere, albeit reduced, at the same time as allowing a reduced stimulation of the medial retina associated with the hemisphere of the brain with the more negative valence. Given the lateral and medial composition of the retina being 60:40, respectively, the overall effect affords stimulation, or otherwise referred to herein as a differential stimulation.

The language “full rim” is art recognized, and used herein to describe frame-fronts that cover the entire edge of a lens, e.g., using an angled recess in the frame-front called a lens groove.

The language “half rim” is art recognized, and used herein to describe frame-fronts are the same as full rim but their lower half is missing. This means the bottom edges of the lenses are exposed, e.g., in certain embodiments secured in place using a thin nylon cord called “Supra.”

The language “hemispheric emotional valence (HEV)” is art-recognized, for example, as described in F. Schiffer, M. Teicher, C. Anderson, A. Tomoda, A. Polcari, C. Navalta, and S. Andersen, Determination of hemispheric emotional valence in individual subjects: a new approach with reasearch and therapeutic implications. Behav Brain Funct 3 (2007) 13 and F. Schiffer, Of Two Minds: The Revolutionary Science of Dual-Brain Psychology, The Free Press, New York, 1998.

The language “integrate” is used herein to describe the action of combining (one thing) with another so that they become a whole. In certain embodiments, the intergration of, for example, the frame of the clip-on accessories for a pair of eyeglasses of the present invention may occur through pressure of the frame against the lens components along the interfaces or using screws or adhesive.

The term “invertible” is used herein to describe the characteristic of the devices of the present invention that may be capable of being flipped to position the same eyeglasses or clip-on accessory for a pair of eyeglasses with the occlusion eye lens component on the left or the right eye.

The language “lateral-medial retina division line” is used herein to describe the line that distinguishes the lateral retina with/from the medial retina, i.e., the vertical line through the macula represents the division between the temporal retina (lateral side) and the nasal retina (medial side). Axons from ganglion cells in the nasal retina cross the midline in the optic chiasm so that their information goes to the visual centers of the opposite side of the brain.

The language “neurologic disorder” is art-recognized and is used herein to describe diseases of the central and peripheral nervous system, e.g., the brain, spinal cord, cranial nerves, peripheral nerves, nerve roots, autonomic nervous system, neuromuscular junction, and muscles. These disorders include epilepsy, Alzheimer disease and other dementias, cerebrovascular diseases including stroke, migraine and other headache disorders, multiple sclerosis, Parkinson's disease, neurological infections, brain tumors, traumatic disorders of the nervous system due to head trauma, and neurological disorders as a result of malnutrition.

As used herein, the term “occlusion” describes the obstruction or blocking of vision deriving from the full or part of a retina.

As used herein, the term “psychiatric disorders” refers to any psychiatric disorders including, but not limited to, depression, attention deficit disorder, schizophrenia, bipolar disorder, anxiety disorders, alcoholism, eating disorders such as anorexia and bulimia, phobias, Asperser's syndrome, dissociative disorders, insomnia, and borderline personality disorder. The ICD-10 diagnostic system, like the earlier DSM-IV, applies to these psychiatric disorders. Psychiatric disorders also include substance abuse disorders (i.e., alcohol abuse or opiate dependence or abuse) caused either by depression or not caused by depression, persistent anxiety, anxiety attacks, feelings of panic, fears of social contacts, nightmares, flashbacks, obsessive thoughts, compulsive behavior, attention disorder, sexual problem, and irrational thinking.

The term “remission” is art-recognized and is used herein to describe the state of absence of disease activity in patients with a chronic illness. Remission is measured using a rating scale, e.g., where a score of greater than fifteen on the rating scale correlates to having an anxiety disorder and a score of ten or less on the rating scale correlates to being in remission and no longer manifesting an abnormal level of anxiety.

As used herein, the term “reversible” or “reversibly” describes any mechanism or action that may be utilized to repeatably place a given item or items in one of two possible states, indefinitely. For example, clip retainer that reversibly affixes the frame to a pair of eyeglasses of a wearer may be affixed or removed from the affixed position, repeatably; this affixing process is considered reversible.

The language “rimless” is art recognized, and used herein to describe frame-fronts that are joined together via a metal bridge. In certain embodiments, the bridge joins and secures the lenses together via screws to make the frame-front. In particular embodiments, at the edges of the lenses, the temples are also attached via screws through the outer-sides of each lens.

As used herein, the terms “subject”, and “patient” are used interchangeably. The terms “subject” and “patient” refer to a human person that is capable of suffering from a brain disorder.

As used herein, and unless otherwise specified, the terms “treat,” “treating” and “treatment” refer to the eradication/remission or amelioration of a disease, disorder, or condition, or of one or more symptoms associated with the disease, disorder or condition as evidenced through symptomology or underlying physiological mechanistics related to the disorder. In certain embodiments, the term “treating” describes enhancing a person's positive outlook or suppressing a person's negative outlook, e.g., this may refer to a person's psychological well-being, including but not limited to their emotional, cognitive, and motivational states, where those persons who are successfully treated can find more appreciation for life, for themselves (improved self-esteem), their work, and their personal relationships. In certain embodiments, the terms describe minimizing the advancement or worsening of the disease, disorder, or condition resulting from the administration of the methods or devices of the present invention to a patient with such a disease, disorder, or condition. In some embodiments, the terms refer to the administration of a method or device provided herein, after the onset of symptoms of the particular disease, disorder, or condition. The terms “treating”, “treatment”, or the like, as used herein covers the treatment of a disease, disorder, or condition in a subject, and includes at least one of: (i) inhibiting the disease, disorder, or condition, i.e., partially or completely halting its progression; (ii) relieving the disease, disorder, or condition, i.e. causing regression of symptoms of the disease, disorder, or condition, or ameliorating a symptom of the disease, disorder, or condition; and (iii) reversal or regression of the disease, disorder, or condition, for example, eliminating or curing of the disease, disorder, or condition.

As used herein, the term “user” is used herein to an individual that wears the glasses or glasses accessories (e.g., clip-on accessory) of the present invention and would benefit from treatment, including both a subject or patient or those that are not suffering from a brain disorder.

The language, “well-being” is used to describe a state of wellness of body, mind and soul, where all are in a state of health, the individual is happy and prospering. Well-being describes the overall welfare of an individual including a good or satisfactory condition of existence. Well-being is a state characterized by health, happiness, and prosperity. In certain embodiments, the well-being affects an individual's performance in a sport or sport-related activity. In particular embodiments, the change in the well-being of the subject provides an enhancement in a sport. In particular, and without wishing to be bound by theory, it is believed that that the devices of the present invention reduce anxiety and promote the positive hemisphere, which in turn, promotes increased performance in sports (e.g., when used during training for the sport). In particular embodiments, the sport may be selected from the group consisting of baseball, golf, basketball, tennis, pickle ball, equestrian, cycling, skating, bowling, boxing, fencing, gymnastics, cricket, volleyball, hockey, table tennis, football, badminton, archery, soccer, running, weightlifting, and lacrosse. In specific embodiments, the sport is selected from golf or baseball (e.g., hitting).

In psychiatry, ICD-10, and the “Diagnostic and Statistical Manual of Mental Disorders, 4th Edition (DSM-IV)” are manuals published by the World Health Organization and American Psychiatric Association (APA), respectively, that includes all currently recognized mental health disorders. However, ICD-10 is now the official standard, and in ICD-10 there are two diagnoses for depression, Major Depression and Dysthymic Disorder, as described below. Each of the diagnostic entities in the ICD-10 are supported not only by clinical descriptions, but also by biological studies that use electroencephalography (EEG), magnetoencephalography (MEG), functional magnetic resonance imaging (fMRI), evoked potentials, electrodermal activity, biochemical markers (catecholamines and catecholamine metabolites; indoleamines and indoleamine metabolites, acetylcholine, histamine, aminoacids, melatonin, prostaglandins, opoid peptides, neupropeptides, enzymes, receptor densities), psychoimmunological markers, genetic markers, and animal models.

The language “Major Depressive Disorder” is characterized by one or more Major Depressive Episodes (i.e., at least 2 weeks of depressed mood or loss of interest accompanied by at least four additional symptoms of depression). Dysthymic Disorder is characterized by at least 2 years of depressed mood for more days than not, accompanied by additional depressive symptoms that do not meet criteria for a Major Depressive Episode.

Criteria for Major Depressive Episode include:
A. Five (or more) of the following symptoms have been present during the same 2-week period and represent a change from previous functioning; at least one of the symptoms is either (1) depressed mood or (2) loss of interest or pleasure. Note: Do not include symptoms that are clearly due to a general medical condition, or mood-incongruent delusions or hallucinations.
   (1) depressed mood most of the day, nearly every day, as indicated by either subjective report (e.g., feels sad or empty) or observation made by others (e.g., appears tearful). Note: In children and adolescents, can be irritable mood.
   (2) markedly diminished interest or pleasure in all, or almost all, activities most of the day, nearly every day (as indicated by either subjective account or observation made by others)
   (3) significant weight loss when not dieting or weight gain (e.g., a change of more than 5% of body weight in a month) or decrease or increase in appetite nearly every day. Note: In children, consider failure to make expected weight gains.
   (4) insomnia or hypersomnia nearly every day
   (5) psychomotor agitation or retardation nearly every day (observable by others, not merely subjective feelings of restlessness or being slowed down)
   (6) fatigue or loss of energy nearly every day
   (7) feelings of worthlessness or excessive or inappropriate guilt (which may be delusional) nearly every day (not merely self-reproach or guilt about being sick)
   (8) diminished ability to think or concentrate, or indecisiveness, nearly every day (either by subjective account or as observed by others)
   (9) recurrent thoughts of death (not just fear of dying), recurrent suicidal ideation without a specific plan, or a suicide attempt or a specific plan for committing suicide
B. The symptoms do not meet criteria for a Mixed Episode.
C. The symptoms cause clinically significant distress or impairment in social, occupational, or other important areas of functioning.
D. The symptoms are not due to the direct physiological effects of a substance (e.g., a drug of abuse, a medication) or a general medical condition (e.g., hypothyroidism).
E. The symptoms are not better accounted for by Bereavement, i.e., after the loss of a loved one, the symptoms persist for longer than 2 months or are characterized by marked functional impairment, morbid preoccupation with worthlessness, suicidal ideation, psychotic symptoms, or psychomotor retardation.

Diagnostic criteria or Dysthymic Disorder include:
A. Depressed mood for most of the day, for more days than not, as indicated either by subjective account or observation by others, for at least 2 years. Note: In children and adolescents, mood can be irritable, and duration must be at least 1 year.
B. Presence, while depressed, of two (or more) of the following:
   (1) poor appetite or overeating
   (2) insomnia or hypersomnia
   (3) low energy or fatigue
   (4) low self-esteem
   (5) poor concentration or difficulty making decisions
   (6) feelings of hopelessness

The DSM-IV (1), the International Classification of Diseases (ICD-10-CM) (2), and as described in The Comprehensive Textbook of Psychiatry (3), thus, define depressive disorders, which in the ICD-10-CM are given specific diagnostic codes: major depression is F33 and dysthymia is F34.1. In distinction from the depressive disorders, the DSM-IV, ICD-10-CM, the Comprehensive Textbook of Psychiatry, and the accepted practice in the profession (4) consider other disorders as separated and distinct psychiatric diagnoses. The ICD-10 list of major categories is as follows:
Disorders Usually First Diagnosed in Infancy, Childhood, or Adolescence
Delirium, Dementia, and Amnestic and Other Cognitive Disorders
Mental Disorders Due to a General Medical Condition
Substance-Related Disorders
Schizophrenia and Other Psychotic Disorders
Mood Disorders
Anxiety Disorders
Somatoform Disorders
Factitious Disorders
Dissociative Disorders
Sexual and Gender Identity Disorders
Eating Disorders
Sleep Disorders
Impulse-Control Disorders Not Elsewhere Classified
Adjustment Disorders
Personality Disorders
   Many patients with dysthymic disorder have brain wave (EEG) abnormalities that mimic those found in major depression such as reduced REM latency, increased REM density, reduced slow-wave sleep, impaired sleep continuity. Patients with dysthymia who have these EEG abnormalities more frequently have a positive family history for major depression. They also respond better to antidepressant medications.

Anxiety disorders have scientific findings that differentiate them from depression and other psychiatric or psychological disorders. In patients with anxiety disorders functional neuroimaging shows abnormalities during symptom provocation tests, in the limbic, paralimbic and sensory association regions. Further, for anxiety there is a general theory of a neural behavioral-inhibition system. This system evaluates stimuli to attempt to determine their level of dangerousness and simultaneously in response produce behavioral inhibition and increase arousal and attention. Antianxiety drugs inhibit brain areas involved in these responses. From animal studies using pharmacological agents and/or brain lesions, anxiety is associated with several interconnected anatomical areas. Sensory stimuli that are interpreted as dangerous activate the hippocampus, especially the entorhinal cortex, which secondarily induces habituation by actions on the lateral and medial septal areas, which then stimulate the cingulate which induces behavioral inhibition. Several specific neurotransmitter systems influence this anxiety mechanism, including noradrenergic activity of the locus coeruleus, serotonergic systems originating in the raphe, and by widespread GABAA-receptor activity (which are the main locus of activity of the benzodiazepines). Stimuli that are interpreted as acute threats activate the “fight or flight” response, which is mediated especially by the locus coeruleus and the amygdala. The amygdala encodes fearful memories and aversive conditioning and participates in the acute fear and negative anticipation that we call anxiety. Further, intense anxiety stimulates the sympathetic nervous system via the locus coeruleus, and this induces tachycardia, tremor, and diaphoresis. The frontal cortex becomes aware of the anxiety and induces behavioral responses which are attempts to improve survival, but which often cause more harm and increase danger. The cingulate, in anxiety disorders, attempts to improve the communication between the cortex and the subcortical areas.

### II. Devices of the Invention

The present invention provides certain devices that are useful in treating brain disorders and stimulating a change in the psychological state of a subject. Such devices include clip-on accessories for a pair of eyeglasses and pairs of eyeglasses.

### A. Clip-On Accessory For Pair Of Eyeglasses

One embodiment of the present invention provides a clip-on accessory for a pair of eyeglasses comprising
a frame, constructed to asymmetrically integrate two eye lens components, incorporating a clip retainer that reversibly affixes the frame to a pair of eyeglasses of a wearer;
an occlusion eye lens component integrated on one side of the frame designed and positioned for full occlusion of a first lateral retina of the first eye of the wearer, wherein the occlusion eye lens component is positioned from (e.g., about) the lateral-medial retina division line of the first eye of the wearer to (e.g., about) the inner corner of the eye of the wearer; and
a tinted eye lens component integrated on the other side of the frame

positioned for view by the entire retina of the second eye of the wearer, wherein the occlusion lens component and the tinted eye lens component are integrated asymmetrically in the frame.

In certain embodiments of the present invention, the eyeglasses upon which the clip-on accessory is clipped is a pair of eyeglasses that have transparent (e.g., mostly transparent) lenses.

i. Frame

The clip-on accessories for a pair of eyeglasses of the present invention comprise a frame, constructed to asymmetrically integrate two eye lens components, incorporating a clip retainer that reversibly affixes the frame to a pair of eyeglasses of a wearer.

The frame may be constructed from any suitable materials that are capable of integrating the two eye lens components. In certain embodiments, the frame may be constructed from plastic or a composite material, e.g., cellulose acetate. In particular embodiments, the frame is constructed of carbon fiber or nylon fiber. In certain embodiments, the frame may be constructed from metal, e.g., wire, or other suitable materials that are capable of integrating the two eye lens components. In particular embodiments, the frame is constructed of titanium, aluminum, or steel. In certain embodiments, the frame may be constructed from natural materials (such as bone, wood, ivory, horn and real tortoise shell).

In certain embodiments of the invention, the frame may be constructed from material selected from the group consisting of cellulose acetate, metal, and high-performance composites (such as carbon fiber).

In certain embodiments of the present invention, the clip retainer is structured to rotate roughly 180 degrees, e.g., into the operational field of view of the wearer or up to 180 degrees away from operational position.

In certain embodiments of the present invention, the clip retainer is invertible to position the occlusion eye lens component on the left or the right side of the wearer. In alternate embodiments, the clip retainer may be utilized in only one position, i.e., where the occlusion eye lens component is positioned on the left or on the right side of the wearer.

ii. Occlusion Eye Lens Component

The clip-on accessories for a pair of eyeglasses of the present invention comprise an occlusion eye lens component integrated on one side of the frame designed and positioned for full occlusion of a first lateral retina of the first eye of the wearer, wherein the occlusion eye lens component is positioned from (e.g., about) the lateral-medial retina division line of the first eye of the wearer to (e.g., about) the inner corner of the eye of the wearer.

The occlusion eye lens component comprises a shape that is designed and positioned for full occlusion of a first lateral retina of the first eye of the wearer from (e.g., about) the lateral-medial retina division line of the first eye of the wearer to (e.g., about) the inner corner of the eye of the wearer. In addition, the thickness of the occlusion eye lens component need only be sufficiently thick to achieve the occlusion. Further, the medial retina of the first eye remains uncovered to stimulate the medial retina, e.g., which in turn stimulates the contralateral hemisphere of the brain. In certain embodiments, the occlusion eye lens component may be formed as part of a lens that is equal in size to the tinted eye lens component, i.e., forming a complete lens with an area of occlusion. In particular embodiments, the area that is not the area of occlusion (i.e., over the medial retina) may be clear. In particular alternative embodiments, the area that is not the area of occlusion may be tinted, which would afford an embodiment that is more lifestyle suitable by making the occluded area look less conspicuous. In specific embodiments, the width of the occlusion area of the occlusion lens component ranges, from about 15 to 40 mm from the midline of the frame, e.g., from about 24 to 30 mm, e.g., about 28 mm.

The occlusion eye lens component may be constructed from any suitable materials that are capable of occluding the vision of an eye. In certain embodiments, the occlusion eye lens component may be constructed from plastic or a composite material, e.g., cellulose acetate. In certain embodiments, the occlusion eye lens component may be constructed from metal or other suitable materials that are capable of occluding the vision of an eye. In certain embodiments, the occlusion eye lens component may be constructed from natural materials (such as bone, wood, ivory, horn and real tortoise shell).

The occlusion eye lens component is integrated on one side of the frame through groove interlocking, pressure connection, adhesive, or through fasteners (e.g. screws or pins). In certain embodiments, the occlusion eye lens component may be integrated around its circumference (e.g., in whole or in part). In certain embodiments, the occlusion eye lens component may be integrated at a point or through a segment of frame material overlapping the occlusion eye lens component.

iii. Tinted Eye Lens Component

The clip-on accessories for a pair of eyeglasses of the present invention comprise a tinted eye lens component integrated on the other side of the frame (i.e., opposite of the occlusion eye lens component) positioned for view by the entire retina of the second eye of the wearer.

The tinted eye lens component may be constructed from any suitable materials that are capable of offering transparency in a reduced amount resulting from tinting, e.g., glass, polymer, or pre-polymer. The tinted transparency results in differential stimulation, i.e., the simultaneous stimulation of the lateral retina of the positive hemisphere, albeit reduced, at the same time as allowing a reduced stimulation of the medial retina associated with the hemisphere of the brain with the more negative valence. The tinting may be comprised of colorants or coatings that reduces light transmission

In certain embodiments of the present invention, the tinted eye lens component may be constructed from glass, e.g., comprising colorants or coatings that reduces light transmission.

In certain embodiments of the present invention, the tinted eye lens component may be constructed from a polymer, e.g., comprising colorants or coatings that reduces light transmission. In particular embodiments, the polymer is polycarbonate.

In certain embodiments of the present invention, the tinted eye lens component may be constructed from a pre-polymer, e.g., comprising colorants or coatings that reduces light transmission. In particular embodiments, the pre-polymer is a urethane-based pre-polymer plastic, e.g., Trivex.

The tinted eye lens component is integrated on one side of the frame through groove interlocking, pressure connection, adhesive, or through fasteners (e.g. screws or pins). In certain embodiments, the tinted eye lens component may be integrated around its circumference (e.g., in whole or in part). In certain embodiments, the tinted eye lens component may be integrated at a point or through a segment of frame material overlapping the tinted eye lens component.

### B. Pair Of Eyeglasses

Another embodiment of the present invention provides a pair of eyeglasses comprising
an eyeglasses frame-front securing two lenses, wherein the frame-front is connected with a bridge and terminating in two temples, constructed to asymmetrically integrate an occlusion eye lens component and a tinted eye lens component;
an occlusion eye lens component integrated on one side of the frame designed and positioned for full occlusion of a first lateral retina of the first eye of the wearer, wherein the occlusion eye lens component is positioned from (e.g., about) the lateral-medial retina division line of the first eye of the wearer to (e.g., about) the inner corner of the eye of the wearer; and
a tinted eye lens component integrated on the other side of the frame positioned for view by the entire retina of the second eye of the wearer,
   wherein the occlusion lens component and the tinted eye lens component are integrated asymmetrically in the frame.

In certain embodiments of the pair of eyeglasses of the present invention, the clip-on accessory described herein may be designed as a permanently fixed addition to the pair of eyeglasses.

In certain embodiments of the present invention, at least one of the occlusion eye lens component or the tinted eye lens component are integrated into the frame-front of the pair of eyeglasses described herein. In certain embodiments, both lens components are integrated.

In certain embodiments of the present invention, the pair eyeglasses is invertible to position the occlusion eye lens component on the left or the right side of the wearer. In alternate embodiments, the pair eyeglasses may be utilized in only one position, i.e., where the occlusion eye lens component is positioned on the left or on the right side of the wearer.

i. Eyeglasses Frame-Front

The pairs of eyeglasses of the present invention comprise an eyeglasses frame-front securing two lenses, wherein the frame-front is connected with a bridge and terminating in two temples, constructed to asymmetrically integrate an occlusion eye lens component and a tinted eye lens component. The eyeglasses frame-front is the main part of the pair of eyeglasses, and secures in place the two lenses of the pair of eyeglasses. The style and aesthetics of the frame-front may be selected from any style or aesthetics that satisfy the structural requirements described herein, e.g., and would allow the pair of eyeglasses to perform their intended function.

In certain embodiments of the present invention, the frame-front comprises a full rim, a half rim, or is rimless.

The frame-front may be constructed from any suitable materials that are capable of integrating the two eye lenses. In certain embodiments, the frame-front may be constructed from plastic or a composite material, e.g., cellulose acetate. In particular embodiments, the frame-front is constructed of carbon fiber or nylon fiber. In certain embodiments, the frame-front may be constructed from metal, e.g., wire, or other suitable materials that are capable of integrating the two eye lens components. In particular embodiments, the frame-front is constructed of titanium, aluminum, or steel. In certain embodiments, the frame-front may be constructed from natural materials (such as bone, wood, ivory, horn and real tortoise shell).

In certain embodiments of the present invention, the frame-front may be constructed from material selected from the group consisting of cellulose acetate, metal, and high-performance composites (such as carbon fiber).

ii. Eyeglasses Additional Components

The eyeglasses of the present invention comprise additional components, including, for example, one or more of the following: the bridge, the lenses, the endpieces, the temples, and the temple tips. In particular embodiments, various screws, pins, and hinges may be used to interconnect components.

In certain embodiments of the present invention, the bridge is a regular bridge, a keyhole bridge, or metal bridge.

In certain embodiments, the endpieces, the temples, and the temple tips are constructed from the same material as the frame-front.

The two lenses component may be constructed from any suitable materials that are capable of offering transparency, e.g., glass, polymer, or pre-polymer. In certain embodiments, the two lenses may be constructed from glass. In certain embodiments, the two lenses may be constructed from a polymer, e.g., wherein the polymer is polycarbonate. In certain embodiments, the two lenses may be constructed from a pre-polymer, e.g., wherein the pre-polymer is a urethane-based pre-polymer plastic, e.g., Trivex. Depending on the type of frame-front, the two lenses may be secured using groove interlocking, pressure connection, adhesive, or through fasteners (e.g. screws or pins). In a particular embodiment, the frame-front is a full rim, e.g., with an angled female recess on the inside of the rim called a lens groove. In a particular embodiment, the frame-front is a half rim, e.g., with a lens groove but with the addition of a Supra cord. In a particular embodiment, the frame-front is rimless, e.g., wherein the lenses are secured via screws into the bridge and endpieces.

In certain embodiments of the present invention, at least one of the two lenses is for correcting vision (i.e., prescription).

In certain embodiments of the present invention, the two lenses are not for correcting vision (i.e., non-prescription).

In certain embodiments of the present invention, the outer surfaces of the lenses are coated with a reflective material, such as gold, silver or aluminum, to provide a uniform appearance to a viewer, thereby giving the impression that the wearer is wearing regular sunglasses.

iii. Occlusion Eye Lens Component

The pairs of eyeglasses of the present invention comprise an occlusion eye lens component integrated on one side of the frame designed and positioned for full occlusion of a first lateral retina of the first eye of the wearer, wherein the occlusion eye lens component is positioned from (e.g., about) the lateral-medial retina division line of the first eye of the wearer to (e.g., about) the inner corner of the eye of the wearer. In certain embodiments, the occlusion eye lens component of the clip-on accessory for a pair of eyeglasses described herein may be designed as a permanently fixed addition to a pair of eyeglasses. In particular embodiments, the occlusion eye lens component is structured to rotate roughly 180 degrees, e.g., into the operational field of view of the wearer or up to 180 degrees away from operational position. In certain embodiments, the occlusion eye lens component is integrated into the frame-front of the pair of eyeglasses described herein.

The occlusion eye lens component comprises a shape that is designed and positioned for full occlusion of a first lateral retina of the first eye of the wearer from (e.g., about) the lateral-medial retina division line of the first eye of the wearer to (e.g., about) the inner corner of the eye of the wearer. In addition, the thickness of the occlusion eye lens component need only be sufficiently thick to achieve the occlusion. Further, the medial retina of the first eye remains uncovered to stimulate the medial retina, e.g., which in turn stimulates the contralateral hemisphere of the brain. In certain embodiments, the occlusion eye lens component may be formed as part of a lens that is equal in size to the tinted eye lens component, i.e., forming a complete lens with an area of occlusion. In particular embodiments, the area that is not the area of occlusion (i.e., over the medial retina) may be clear. In particular alternative embodiments, the area that is not the area of occlusion may be tinted, which would afford an embodiment that is more lifestyle suitable by making the occluded area look less conspicuous. In specific embodiments, the width of the occlusion area of the occlusion lens component ranges, from about 15 to 40 mm from the midline of the frame-front of the eyeglasses, e.g., from about 24 to 30 mm, e.g., about 28 mm.

In certain embodiments of the present invention, the occlusion eye lens component is formed as part of an amalgamated lens that is equal in total size to the tinted eye lens component and comprises an area of occlusion positioned from about the lateral-medial retina division line of the first eye of the wearer to about the inner corner of the eye of the wearer, wherein the remainder of the amalgamated lens is clear or tinted, e.g., and positioned over the medial retina.

The occlusion eye lens component may be constructed from any suitable materials that are capable of occluding the vision of an eye. In certain embodiments, the occlusion eye lens component may be constructed from plastic or a composite material, e.g., cellulose acetate. In certain embodiments, the occlusion eye lens component may be constructed from metal or other suitable materials that are capable of occluding the vision of an eye. In certain embodiments, the occlusion eye lens component may be constructed from natural materials (such as bone, wood, ivory, horn and real tortoise shell).

In certain embodiments of the present invention, the occlusion eye lens component is integrated on one side of the frame-front through groove interlocking, pressure connection, adhesive, or through fasteners (e.g. screws or pins). In certain embodiments, the occlusion eye lens component may be integrated around its circumference (e.g., in whole or in part). In certain embodiments, the occlusion eye lens component may be integrated at a point or through a segment of frame-front material overlapping the occlusion eye lens component.

iv. Tinted Eye Lens Component

The pairs of eyeglasses of the present invention comprise a tinted eye lens component integrated on the other side of the frame positioned for view by the entire retina of the second eye of the wearer. In certain embodiments, the tinted eye lens component of the clip-on accessory for a pair of eyeglasses described herein may be designed as a permanently fixed addition to a pair of eyeglasses. In certain embodiments, the tinted eye lens component is integrated into the frame-front of the pair of eyeglasses described herein, e.g., wherein the tinted eye lens component is one of the two lenses secured in the eyeglasses frame-front.

In certain embodiments, the tinted eye lens component of the clip-on accessory for a pair of eyeglasses described herein may be designed as a permanently fixed addition to a pair of eyeglasses. In particular embodiments, the tinted eye lens component is structured to rotate roughly 180 degrees, e.g., into the operational field of view of the wearer or up to 180 degrees away from operational position. In certain embodiments, the tinted eye lens component is integrated into the frame-front of the pair of eyeglasses described herein.

In certain embodiments of the present invention, the tinted eye lens component is integrated on one side of the frame-front through groove interlocking, pressure connection, adhesive, or through fasteners (e.g. screws or pins). In certain embodiments, the tinted eye lens component may be integrated around its circumference (e.g., in whole or in part). In certain embodiments, the tinted eye lens component may be integrated at a point or through a segment of frame material overlapping the tinted eye lens component.

The tinted eye lens component may be constructed from any suitable materials that are capable of offering transparency in a reduced amount resulting from tinting, e.g., glass, polymer, or pre-polymer. The tinted transparency results in differential stimulation, i.e., the simultaneous stimulation of the lateral retina of the positive hemisphere, albeit reduced, at the same time as allowing a reduced stimulation of the medial retina associated with the hemisphere of the brain with the more negative valence. The tinting may be comprised of colorants or coatings that reduces light transmission

In certain embodiments of the present invention, the tinted eye lens component may be constructed from glass, e.g., comprising colorants or coatings that reduces light transmission.

In certain embodiments of the present invention, the tinted eye lens component may be constructed from a polymer, e.g., comprising colorants or coatings that reduces light transmission. In particular embodiments, the polymer is polycarbonate.

In certain embodiments of the present invention, the tinted eye lens component may be constructed from a pre-polymer, e.g., comprising colorants or coatings that reduces light transmission. In particular embodiments, the pre-polymer is a urethane-based pre-polymer plastic, e.g., Trivex.

In certain embodiments, the tinted eye lens component is integrated on one side of the frame through groove interlocking, pressure connection, adhesive, or through fasteners (e.g. screws or pins). In certain embodiments, the tinted eye lens component may be integrated around its circumference (e.g., in whole or in part). In certain embodiments, the tinted eye lens component may be integrated at a point or through a segment of frame material overlapping the tinted eye lens component.

### III. Methods of the Invention

### A. Treating a Brain Disorder

The devices of the present invention may be used to treat a brain disorder characterized by neurologic or psychiatric disorder symptomology with a lateralized difference in hemispheric emotional valence.

Accordingly, one embodiment of the present invention provides a method for treatment of a brain disorder characterized by neurologic or psychiatric disorder symptomology with a lateralized difference in hemispheric emotional valence, comprising
identifying a patient with a brain disorder;
measuring a left hemispheric emotional valence for a left hemisphere of a brain of the patient and a right hemispheric emotional valence for a right hemisphere of the brain of the patient to identify a patient with a lateralized difference in hemispheric emotional valence;
determining which hemisphere of the brain of the patient with a lateralized difference in hemispheric emotional valence has a more positive valence, and which hemisphere of the brain has a more negative valence; and
applying to the patient a clip-on accessory for a pair of eyeglasses of the present invention or a pair of eyeglasses of the present invention, wherein the occlusion lens component is designed and positioned for full occlusion of the lateral retina associated with the hemisphere of the brain with the more negative valence combined with differential stimulation of the opposing retina,
   such that the brain disorder with lateralized difference in hemispheric emotional valence is treated in said patient.

In certain embodiments of the present invention, the brain disorder may be selected from the group consisting of depression, attention deficit disorder, schizophrenia, bipolar disorder, anxiety disorders, substance abuse disorders such as alcohol abuse and drug abuse, eating disorders such as anorexia and bulimia, phobias, Asperser's syndrome, dissociative disorders, insomnia, borderline personality disorder, general well-being, Alzheimer's Disease, Parkinson's Disease, Autism, Stroke and any combinations thereof.

In certain embodiments of the present invention, the brain disorder includes one of persistent anxiety, anxiety attacks, feelings of panic, fears of social contacts, obsessive-compulsive disorder, phobias, post-traumatic stress disorder, or generalized anxiety disorder.

i. Identifying Patient With A Brain Disorder

The methods of the present invention comprise the step of identifying a patient with a brain disorder.

In certain embodiments, the brain disorder may be selected from the group consisting of depression, attention deficit disorder, schizophrenia, bipolar disorder, anxiety disorders, substance abuse disorders such as alcohol abuse and drug abuse, eating disorders such as anorexia and bulimia, phobias, Asperser's syndrome, dissociative disorders, insomnia, borderline personality disorder, general well-being, Alzheimer's Disease, Parkinson's Disease, Autism, Stroke and any combinations thereof,

In certain embodiments, the brain disorder includes one of persistent anxiety, anxiety attacks, feelings of panic, fears of social contacts, obsessive-compulsive disorder, phobias, post-traumatic stress disorder, and generalized anxiety disorder.

In one embodiment, the methods of the present invention may be used to treat the human brain for psychological, psychiatric, depressive, neurological, general well-being and other conditions. In one embodiment, the methods of the present invention may be used to treat depression. In one embodiment, the methods of the present Invention may be used to treat psychiatric disorders other than depression including, but not limited to, attention deficit disorder, schizophrenia, bipolar disorder, anxiety disorders, substance abuse disorders such as alcohol abuse and drug abuse, eating disorders such as anorexia and bulimia, phobias, Asperser's syndrome, dissociative disorders, insomnia, borderline personality disorder or any combination thereof. In one embodiment, the methods of the present invention may be used to treat other psychiatric or psychological disorders including, but not limited to, persistent anxiety, anxiety attacks, feelings of panic, fears of social contacts, nightmares, flashbacks, alcohol or drug abuse, obsessive thoughts, compulsive behavior, attention disorder, sexual problem, eating disorder such as anorexia, bulimia or obesity, irrational thinking, or any combination thereof. In one embodiment, the methods of the present invention may be used to treat psychiatric disorders that are co-morbid or co-existent with depression. In one embodiment, the methods of the present invention may be used to treat more than one psychiatric disorder at a given time. For instance, the method may treat a patient having both depression and attention deficit disorder or a patient having both anorexia and insomnia. In one embodiment, the methods of the present invention may be used to benefit persons who do not have any psychological disorders. For patients without any of the above psychological disorders, the methods of the present invention may help improve their psychological well-being and enhance their positive outlook. These patients can find more appreciation for life, for themselves (improved self-esteem), their work, and their personal relationships. The methods of the present invention may improve patient self-confidence, positive disposition, interpersonal relationships, and/or quality of life. In certain embodiments, the methods may also assist in the diagnosis of brain disorders.

In certain embodiments of the present invention, the methods of the present invention may be used benefit patients with a history of opiate dependence by improving their psychological well-being, and/or reducing opioid cravings and use.

ii. Measuring Hemispheric Emotional Valence

The methods of the present invention comprise the step of measuring a left hemispheric emotional valence for a left hemisphere of a brain of the patient and a right hemispheric emotional valence for a right hemisphere of the brain of the patient to identify a patient with a lateralized difference in hemispheric emotional valence. In this respect, the step of measuring hemispheric emotional valence (HEV), in certain embodiments may include the use of lateral visual field stimulation (LVFS).

In an embodiment, the methods of the present disclosure may include the use of the presently described pair of eyeglasses or clip-on accessory for measuring hemispheric emotional valence (HEV) using LVFS. The wearer is asked to look through the glasses or clip-on accessory wherein the occlusion lens component is positioned over one eye, or alternatively the other eye. Any scale may be used to score this process that describes how a person feels on one side versus the other. In a particular embodiment, the determination of the lateralized difference in hemispheric emotional valence with the more positive valence and with the more negative valence comprises the steps of:
providing a first clip-on accessory for a pair of eyeglasses of the present invention or a first pair of eyeglasses of the present invention to the subject, wherein the occlusion lens component is designed and positioned for full occlusion of the lateral retina of the left hemisphere and differential stimulation of the retina of the opposing retina;
assessing the change in the psychological state of the subject of the occlusion and differential stimulation of the first clip-on accessory for a pair of eyeglasses or a first pair of eyeglasses;
providing second clip-on accessory for a pair of eyeglasses of the present invention or a second pair of eyeglasses of the present invention to the subject, wherein the occlusion lens component is designed and positioned for full occlusion of the lateral retina of the right hemisphere and differential stimulation of the retina of the opposing retina;
assessing the change in the psychological state of the subject of the occlusion and differential stimulation of the second clip-on accessory for a pair of eyeglasses or a second pair of eyeglasses; and
comparing the first and second clip-on accessory for a pair of eyeglasses or pair of eyeglasses, to determine which hemisphere of the brain of a subject with a lateralized difference in hemispheric emotional valence has a more positive valence and which has a more negative valence, wherein the glasses that produce the more favorable change in psychological state determine the more negative valence associated with the lateral retina over which the occlusion lens component is designed and positioned for full occlusion. In certain embodiments, where the pair of eyeglasses is invertible, the first pair of eyeglasses is the same as pair of eyeglasses as the second pair of eyeglasses. In certain embodiments, where the clip-on accessory for a pair of eyeglasses is invertible, the first clip-on accessory for a pair of eyeglasses is the same as pair of eyeglasses as the second clip-on accessory for a pair of eyeglasses.

In another embodiment, the methods of the present disclosure may alternatively include the use of glasses for the LVFS, such as safety glasses or goggles, taped or covered so that they permit vision to only one lateral visual field at a time. The wearer is asked to look to one side and to fixate the center of his vision on the edge of the tape so that he or she is looking out of the lateral half of one eye. Vision from the other eye is occluded by the tape on the other side. Any scale may be used to score this process that describes how a person feels on one side versus the other.

In certain embodiments, while utilizing the LVFS, the patient is asked to look at a photograph of a man or woman with a mildly angry facial expression. After 45 seconds, he or she is asked to verbally rate his or her present feelings for each of 10 affects from Positive and Negative Affect Scale (PANAS), from none to extreme on a 5-point scale.

iii. Determining Hemispheric Positive Valence And Negative Valence

The methods of the present invention comprise the step of determining which hemisphere of the brain of the patient with a lateralized difference in hemispheric emotional valence has a more positive valence, and which hemisphere of the brain has a more negative valence.

In one embodiment, the PANAS score may be used to determine the hemisphere of the brain with a positive valence and the hemisphere of the brain with a negative valence. In particular, following the PANAS measurements, the patient is asked to rest for 1 minute looking straight ahead so that vision from both eyes is occluded. The patient is then asked to repeat the procedure by looking out of the second visual field.

The PANAS has 5 positive affects including alert, inspired, determined, attentive, active and 5 negative affects including upset, hostile, ashamed, nervous, and afraid. For each visual field, the sum of the scores on the 5 negative affects is subtracted from the scores from the 5 positive effects and the difference is the PANAS score. The score measured when the person looks out of the right lateral visual field (RVF) is subtracted from the score measured when the person looks out of the left lateral visual field (LFV). The LVF is indicative of the state of the right hemisphere since the connection between the medial retinas and the cerebral hemispheres are crossed. Since a more positive PANAS score indicates more positive affect, we assign a value for the person's HEV according to the formula: LVF PANAS score-RVF PANAS. A positive score suggests that the right hemisphere has a more positive HEV. Research studies show that LVFS offers a good indication that the left and right cerebral hemispheres are generally associated with different emotional valences such that one hemisphere (either left or right) is associated with a more positive outlook on the world (positive hemispheric valence) and the other a more negative outlook on the world (negative hemispheric valence).

A person's personality and some of the person's psychological characteristics may be affected by which hemisphere, right or left hemisphere, dominates. The eyes are connected to the brain so that vision to the left side of a person goes first to the opposite (right) hemisphere and vision to the right side of a person goes first to the left hemisphere. One hemisphere can be stimulated over the other by restricting vision to a portion of the retina of an eye that is connected to a particular hemisphere of the brain. For instance, LVFS has been shown by fMRI to induce a very large increase in brain activity in the hemisphere opposite the visual field, when the patient looked out of the left visual field (LVF) and the right visual field (RVF). As an example, a person looking out of one visual field might see another person as very critical of him and he might feel very critical of himself. Looking out the opposite visual field he is apt to see another person as quite approving of him and he is apt to see himself positively.

iv. Applying the Devices of the Invention

The methods of the present invention comprise the step of applying to the patient a clip-on accessory for a pair of eyeglasses of the present invention or a pair of eyeglasses of the present invention, wherein the occlusion lens component is designed and positioned for full occlusion of the lateral retina associated with the hemisphere of the brain with the more negative valence combined with differential stimulation of the opposing retina.

In particular, once the hemisphere of the brain that has a more negative valence is determined, the clip-on accessory for a pair of eyeglasses of the present invention or the pair of eyeglasses of the present invention are selected such the occlusion lens component is designed and positioned for full occlusion of the lateral retina associated with the hemisphere of the brain with the more negative valence combined with differential stimulation of the opposing retina. The patient then applies the clip-on accessory for a pair of eyeglasses of the present invention or the pair of eyeglasses of the present invention by wearing them for sufficient time, such that the brain disorder with lateralized difference in hemispheric emotional valence is treated in said patient. In certain embodiments, such time ranges from seconds to minutes, to hours, and may be tailored for an individual based on subjective results of treatment.

### V. Combination Therapies

In certain embodiments, the methods of the present invention may be used in combination with any known or existing treatment. For example, the methods and devices of the present invention may be used in combination with other treatments for brain disorders like depression, including antidepressants and talk therapy. Other combination therapies may include, for example, directing light through the scalp of the patient to a target area of the brain, applying an electromagnetic field, electro-convulsive therapy, benzodiazepams (such as diazepam or klonazepam) which are common treatments for anxiety disorders, antipsychotic medications for schizophrenia, bisulfiram for the treatment of alcohol dependence, or buprenorphine for opiate dependence.

In certain embodiments, the methods of the present invention may be combined with other types of treatments for an improved therapeutic effect. For example, treatment can include directing light through the scalp of the patient to a target area of the brain concurrently with applying an electromagnetic field to the brain. The light may be applied with a desired power density and with a desired electromagnetic field strength at the target area.

### B. Stimulating Change in Psychological State

The devices of the present invention may also be used for stimulating a change in the psychological state of a subject.

Accordingly, another embodiment of the present invention provides a method for stimulating a change in the psychological state of a subject, comprising the steps of:
determining which hemisphere of the brain of a subject with a lateralized difference in hemispheric emotional valence has a more positive valence and which has a more negative valence;
applying to the subject a clip-on accessory for a pair of eyeglasses of the present invention or a pair of eyeglasses of the present invention, wherein the occlusion lens component is designed and positioned for full occlusion of the lateral retina associated with the hemisphere of the brain with the more negative valence combined with differential stimulation of the opposing retina; and
   such that the full occlusion of lateral retina associated with the hemisphere of the brain with the more negative valence combined with differential stimulation of the opposing retina provides favorable change in the psychological state of the subject.

In certain embodiments of the present invention, the change in the psychological state of the subject includes a change of psychological symptoms displayed by the subject.

In certain embodiments of the present invention, the change in the psychological state of the subject includes a change in the well-being of the subject. In certain embodiments, the change in the well-being of the subject provides an enhancement in a sport. In particular embodiments, the sport may be selected from the group consisting of baseball, golf, basketball, tennis, pickle ball, equestrian, cycling, skating, bowling, boxing, fencing, gymnastics, cricket, volleyball, hockey, table tennis, football, badminton, archery, soccer, running, weightlifting, and lacrosse. In particular embodiments, the sport is selected from golf or baseball (e.g., hitting or pitching).

i. Determining Hemispheric Positive Valence And Negative Valence

The methods of the present invention comprise the step of determining which hemisphere of the brain of a subject with a lateralized difference in hemispheric emotional valence has a more positive valence and which has a more negative valence;

In certain embodiments of the present invention, the determination of the lateralized difference in hemispheric emotional valence with the more positive valence and with the more negative valence comprises the steps of:
providing a first clip-on accessory for a pair of eyeglasses of the present invention or a first pair of eyeglasses of the present invention to the subject, wherein the occlusion lens component is designed and positioned for full occlusion of the lateral retina of the left hemisphere and differential stimulation of the retina of the opposing retina;
assessing the change in the psychological state of the subject of the occlusion and differential stimulation of the first clip-on accessory for a pair of eyeglasses or a first pair of eyeglasses;
providing second clip-on accessory for a pair of eyeglasses of the present invention or a second pair of eyeglasses of the present invention to the subject, wherein the occlusion lens component is designed and positioned for full occlusion of the lateral retina of the right hemisphere and differential stimulation of the retina of the opposing retina;
assessing the change in the psychological state of the subject of the occlusion and differential stimulation of the second clip-on accessory for a pair of eyeglasses or a second pair of eyeglasses; and
comparing the first and second clip-on accessory for a pair of eyeglasses or pair of eyeglasses, to determine which hemisphere of the brain of a subject with a lateralized difference in hemispheric emotional valence has a more positive valence and which has a more negative valence, wherein the glasses that produce the more favorable change in psychological state determine the more negative valence associated with the lateral retina over which the occlusion lens component is designed and positioned for full occlusion. In certain embodiments, where the pair of eyeglasses is invertible, the first pair of eyeglasses is the same as pair of eyeglasses as the second pair of eyeglasses. In certain embodiments, where the clip-on accessory for a pair of eyeglasses is invertible, the first clip-on accessory for a pair of eyeglasses is the same as pair of eyeglasses as the second clip-on accessory for a pair of eyeglasses.

In another embodiment, the methods of the present disclosure may alternatively include the use of glasses for the LVFS, such as safety glasses or goggles, taped or covered so that they permit vision to only one lateral visual field at a time. The wearer is asked to look to one side and to fixate the center of his vision on the edge of the tape so that he or she is looking out of the lateral half of one eye. Vision from the other eye is occluded by the tape on the other side. Any scale may be used to score this process that describes how a person feels on one side versus the other.

In certain embodiments, the subject is asked to look at a photograph of a man or woman with a mildly angry facial expression. After 45 seconds, he or she is asked to verbally rate his or her present feelings for each of 10 affects from Positive and Negative Affect Scale (PANAS), from none to extreme on a 5-point scale.

In one embodiment, the PANAS score may be used to determine the hemisphere of the brain with a positive valence and the hemisphere of the brain with a negative valence. In particular, following the PANAS measurements, the patient is asked to rest for 1 minute looking straight ahead so that vision from both eyes is occluded. The subject is then asked to repeat the procedure by looking out of the second visual field. The PANAS has 5 positive affects including alert, inspired, determined, attentive, active and 5 negative affects including upset, hostile, ashamed, nervous, and afraid. For each visual field, the sum of the scores on the 5 negative affects is subtracted from the scores from the 5 positive effects and the difference is the PANAS score. The score measured when the person looks out of the right lateral visual field (RVF) is subtracted from the score measured when the person looks out of the left lateral visual field (LFV). The LVF is indicative of the state of the right hemisphere since the connection between the medial retinas and the cerebral hemispheres are crossed. Since a more positive PANAS score indicates more positive affect, we assign a value for the person's HEV according to the formula: LVF PANAS score-RVF PANAS. A positive score suggests that the right hemisphere has a more positive HEV. Research studies show that LVFS offers a good indication that the left and right cerebral hemispheres are generally associated with different emotional valences such that one hemisphere (either left or right) is associated with a more positive outlook on the world (positive hemispheric valence) and the other a more negative outlook on the world (negative hemispheric valence).

ii. Applying the Devices of the Invention

The methods of the present invention comprise the step of applying to the subject a clip-on accessory for a pair of eyeglasses of the present invention or a pair of eyeglasses of the present invention, wherein the occlusion lens component is designed and positioned for full occlusion of the lateral retina associated with the hemisphere of the brain with the more negative valence combined with differential stimulation of the opposing retina.

In particular, once the hemisphere of the brain that has a more negative valence is determined, the clip-on accessory for a pair of eyeglasses of the present invention or the pair of eyeglasses of the present invention are selected such the occlusion lens component is designed and positioned for full occlusion of the lateral retina associated with the hemisphere of the brain with the more negative valence combined with differential stimulation of the opposing retina. The patient then applies the clip-on accessory for a pair of eyeglasses of the present invention or the pair of eyeglasses of the present invention by wearing them for sufficient time, such that the full occlusion of lateral retina associated with the hemisphere of the brain with the more negative valence combined with differential stimulation of the opposing retina provides favorable change in the psychological state of the subject. In certain embodiments, such time ranges from seconds to minutes, to hours, and may be tailored for an individual based on subjective results of treatment.

### VI. Design Aspects of the Invention

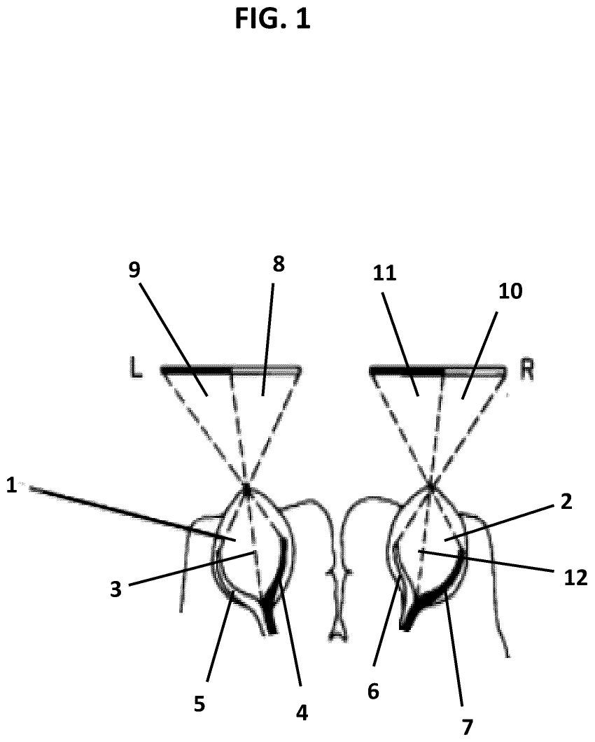

Independent of the utility related to the methods and devices of the present invention, the ornamental appearance of any novel design provided herein is intended to be part of this invention, for example, each of the perspective views in FIGS. 1 through 8, which may form an independent or combined ornamental appearance of the devices described herein.

Accordingly, one embodiment of the present invention provides an ornamental design for a clip-on accessory for a pair of eyeglasses or pair of eyeglasses comprising of the present invention as shown and described.

### Exemplification

Having thus described the invention in general terms, reference will now be made to exemplary embodiments, and the accompanying drawings of exemplary embodiments, which are not necessarily drawn to scale, and which are not intended to be limiting in any way.

In this respect, it is to be understood that the invention is not limited in its application to the details of construction and to the arrangements of the components set forth in the following description or illustrated in the Figures. The invention is capable of other embodiments and of being practiced and carried out in various ways. Also, it is to be understood that the phraseology and terminology employed herein are for the purpose of description and should not be regarded as limiting.

FIG. 1 depicts a schematic diagram of the eyes, the retinas (i.e., lateral and medial), and how each contribute to the visual fields. Left eye 1 comprises lateral retina 5 and medial retina 4 that are divided according to the noted lateral-medial retina division line 3. Right eye 2 comprises lateral retina 7 and medial retina 6 that are divided according to the noted lateral-medial retina division line 12.

The lateral visual field 8 of the left eye 1 is combined with the medial visual field 10 is associated with the left hemisphere of the brain to produce the right visual field. The lateral visual field 11 of the right eye 2 is combined with the medial visual field 9 is associated with the right hemisphere of the brain to produce the left visual field.

### Example 1

### Exemplary Clip-On Accessory for a Pair of Eyeglasses

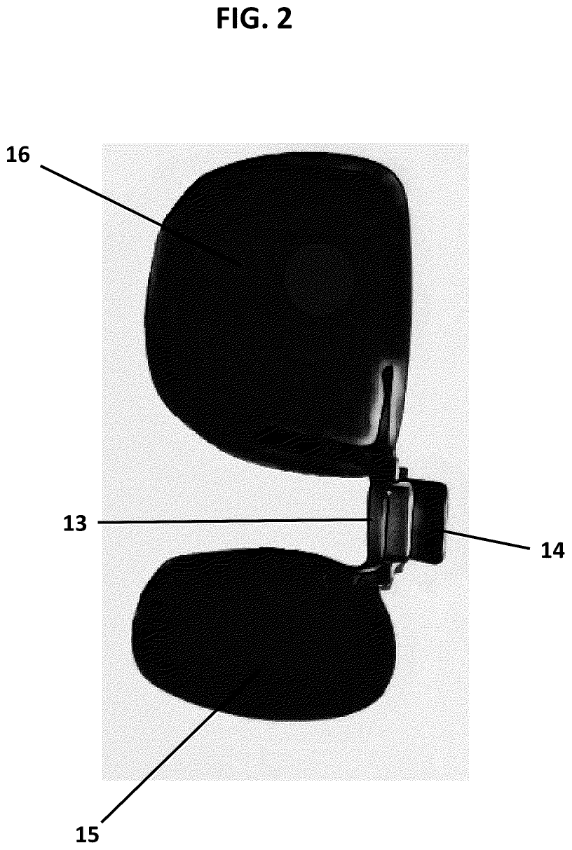

One embodiment of the clip-on accessories for a pair of eyeglasses of the present invention is shown in FIG. 2. FIG. 2 is a front perspective view of one embodiment of the clip-on accessories for a pair of eyeglasses of the present invention, wherein the occlusion eye lens component would present on the left eye of the wearer. Frame 13 is constructed to asymmetrically integrate two eye lens components, incorporating a clip retainer 14 that reversibly affixes the frame 13 to a pair of eyeglasses of a wearer. The occlusion eye lens component 15 is integrated on one side of the frame 13 designed and positioned for full occlusion of a first lateral retina of the first eye of the wearer, wherein the occlusion eye lens component 15 is positioned from about the lateral-medial retina division line of the first eye of the wearer to about the inner corner of the eye of the wearer. The tinted eye lens component 15 is integrated on the other side of the frame 13 positioned for view by the entire retina of the second eye of the wearer.

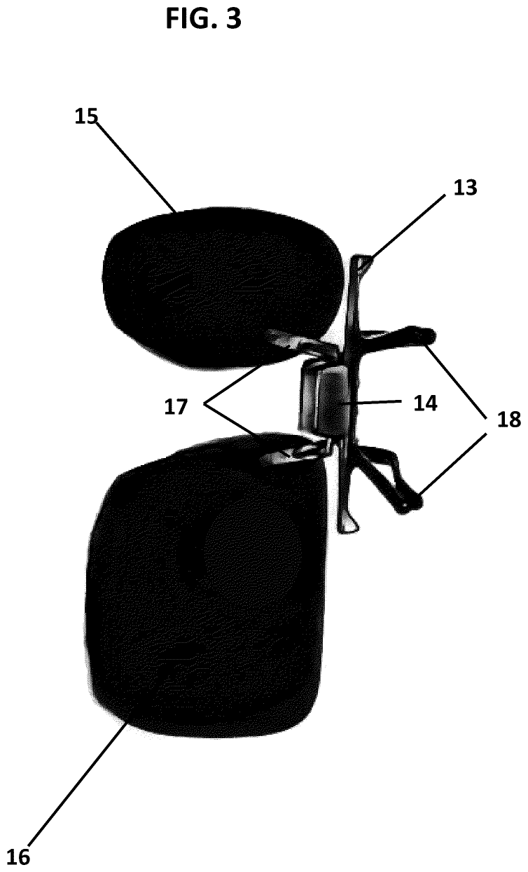

FIG. 3 is a rear perspective view the clip-on accessory for a pair of eyeglasses depicted in FIG. 2. Frame 13 is more clearly depicted from this rear perspective view. Clip retainer 14, comprising clips 18 (i.e., which clip to the glasses of the wearer) is structured and depicted as rotated roughly 180 degrees, e.g., into the operational field of view of the wearer or up to 180 degrees away from operational position. Occlusion lens component 15 and tinted eye lens component 16 are integrated to frame 13 through segments of frame material 17 overlapping the tinted eye lens component 16 and occlusion lens component 15; such segments of frame material are attached at least by two screws.

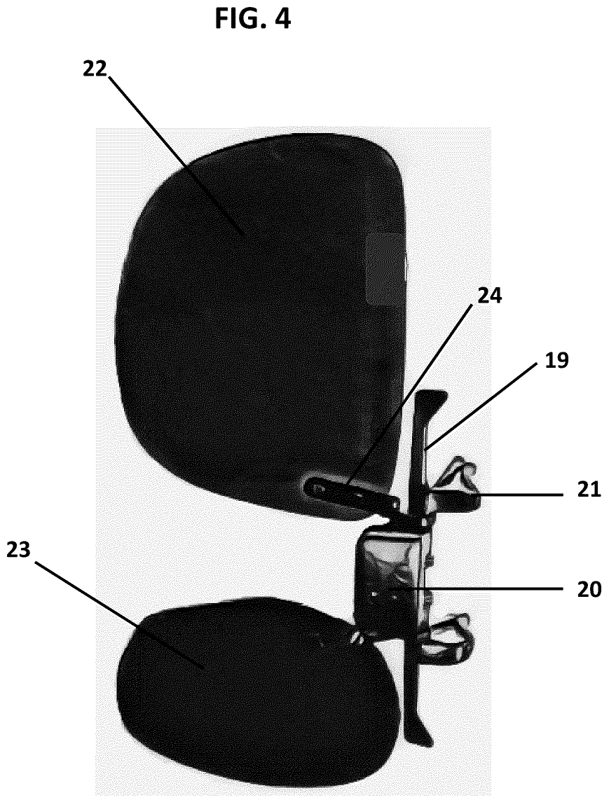

FIG. 4 is a rear perspective view of one embodiment of the clip-on accessories for a pair of eyeglasses of the present invention, wherein the occlusion eye lens component would present on the right eye of the wearer. Frame 19 is depicted from this rear perspective view. Clip retainer 20, comprising clip 21 (i.e., which clip to the glasses of the wearer) is structured and depicted as rotated roughly 180 degrees, e.g., into the operational field of view of the wearer or up to 180 degrees away from operational position. Occlusion lens component 23 and tinted eye lens component 22 are integrated to frame 19 through segments of frame material 24 overlapping the tinted eye lens component 22 and occlusion lens component 23; such segments of frame material are attached at least by two screws.

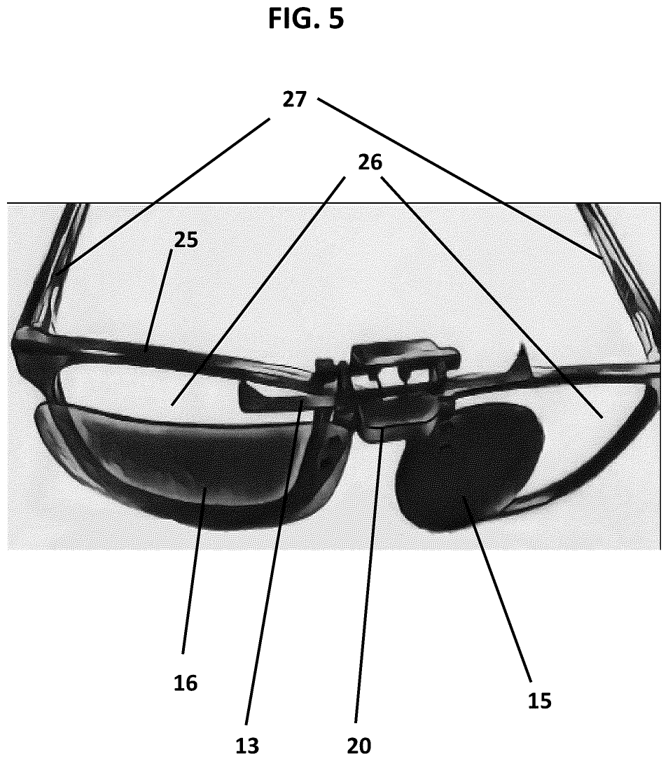

FIG. 5 is a front perspective top down view of the clip-on accessory for a pair of eyeglasses depicted in FIG. 2, presented as clipped onto a pair of eyeglasses with temples open. Clip retainer 20 incorporated on frame 13 is used to clip the clip-on accessory depicted in FIG. 2 to frame-front 25, secured on two lenses 26, wherein the frame-front is connected with a bridge and terminating in two temples 27, constructed to asymmetrically integrate/position the occlusion eye lens component 15 and a tinted eye lens component 16.

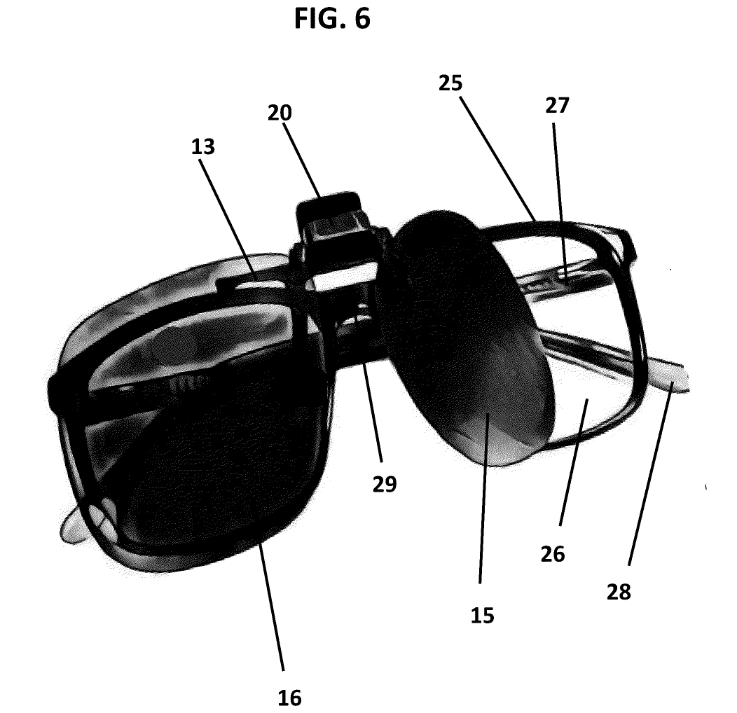

FIG. 6 is a front perspective view of the clip-on accessory for a pair of eyeglasses depicted in FIG. 2, presented as clipped onto a pair of eyeglasses with temples folded closed. Clip retainer 20 incorporated on frame 13 is used to clip the clip-on accessory depicted in FIG. 2 to frame-front 25, secured on two lenses 26, wherein the frame-front is connected with a regular bridge 29 and terminating in two temples 27, and ultimately in temple tips 28, constructed to asymmetrically integrate/position the occlusion eye lens component 15 and a tinted eye lens component 16.

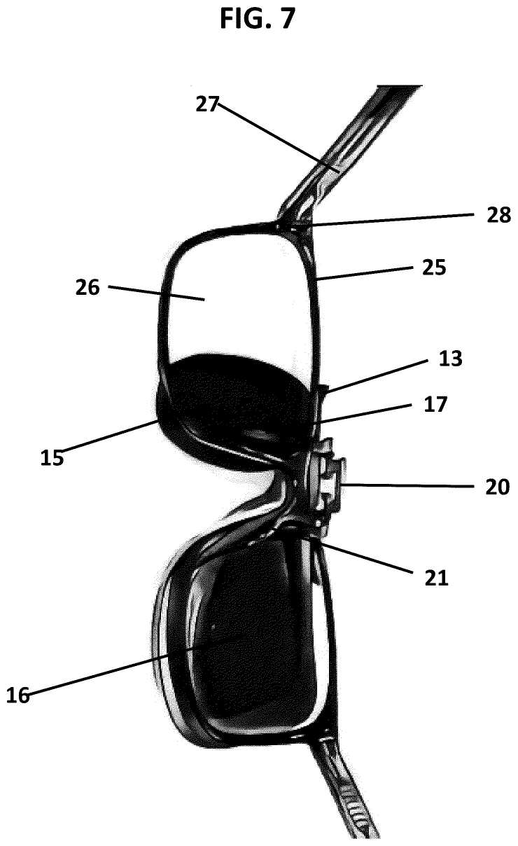

FIG. 7 is a rear perspective view of the clip-on accessory for a pair of eyeglasses depicted in FIG. 2, presented as clipped onto a pair of eyeglasses with temples open. Clip retainer 20 incorporated on frame 13, shown with clips 21, is used to clip the clip-on accessory depicted in FIG. 2 to frame-front 25, secured on two lenses 26, wherein the frame-front is connected with a bridge and terminating in two temples 27 with hinge 28 connecting the frame-front 25 to temples 27, and constructed to asymmetrically integrate/position the occlusion eye lens component 15 and a tinted eye lens component 16.

### Example 2

### Exemplary Pair of Eyeglasses

### Example 2A

An exemplary pair of eyeglasses of the present invention may be prepared by permanently affixing the clip-on accessories of Example 1 to the full rim frame-front of the eyeglasses depicted in FIGS. 5, 6 and 7, and therefore comprising
an eyeglasses frame-front securing two lenses, wherein the frame-front is connected with a bridge and terminating in two temples, constructed to asymmetrically integrate an occlusion eye lens component and a tinted eye lens component;
an occlusion eye lens component integrated on one side of the frame designed and positioned for full occlusion of a first lateral retina of the first eye of the wearer, wherein the occlusion eye lens component is positioned from (e.g., about) the lateral-medial retina division line of the first eye of the wearer to (e.g., about) the inner corner of the eye of the wearer; and
a tinted eye lens component integrated on the other side of the frame positioned for view by the entire retina of the second eye of the wearer,
   wherein the occlusion lens component and the tinted eye lens component are integrated asymmetrically in the frame.

### Example 2B

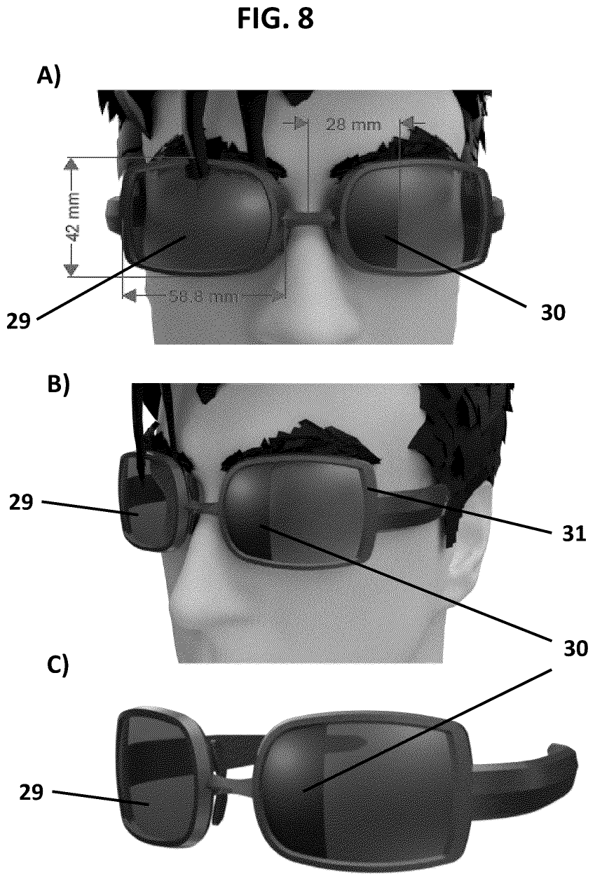

Another exemplary pair of eyeglasses of the present invention may be prepared as an invertible pair of eyeglasses as shown in FIG. 8. FIG. 8A) is a front perspective view of a wearer wearing a pair of eyeglasses of the present invention that is designed to invertible with the occlusion lens component shown on the left eye of the user formed as part of a lens that is equal in size to the tinted eye lens component where the area that is not the area of occlusion is tinted, shown with dimension examples; B) a front perspective view showing the eyeglasses of 8A with the wearers head at an angle turning to the right; and C) a front perspective view showing the eyeglasses of 8A alone and at angle to the right.

The occlusion eye lens component 30 comprises a shape that is designed and positioned for full occlusion of a first lateral retina of the first eye of the wearer from (e.g., about) the lateral-medial retina division line of the first eye of the wearer to (e.g., about) the inner corner of the eye of the wearer. The occlusion eye lens component 30 is formed as part of a lens that is equal in size to the tinted eye lens component 29, i.e., forming a complete lens with an area of occlusion. The area that is not the area of occlusion is tinted, which affords an embodiment that is more lifestyle suitable by making the occluded area look less conspicuous. The width of the occlusion area of the occlusion lens component ranges, 28 mm from the midline of the frame-front 31 of the eyeglasses.

### Example 3

### Exemplary Methods of Treating

Prior to all treatments it was first determined which hemisphere had a more positive HEV and which, more negative. The methods and devices of the present invention are useful in treating a brain disorder or for changing the psychological state of a user.

In particular embodiments, the devices of the present invention are worn at various times, such as during psychotherapy counseling sessions and times of anxiety or at any time the wearer wants to decrease their stress. The devices are worn for a sufficient period of time that can be in the range of between a few minutes and many hours to stimulate the user to achieve a change in the psychological state of the user. For example, the devices can be worn by a passenger on an airplane to help reduce the anxiety of flying. In another embodiment, the devices are worn at home or in the office during a period of anxiety. In a further embodiment, the devices are worn to practice or play a sport, e.g., to reduce anxiety and enhance performance.

### INCORPORATION BY REFERENCE

The entire contents of all patents, published patent applications and other references cited herein are hereby expressly incorporated herein in their entireties by reference.

### EQUIVALENTS

Those skilled in the art will recognize, or be able to ascertain using no more than routine experimentation, numerous equivalents to the specific procedures described herein. Such equivalents were considered to be within the scope of this invention and are covered by the following claims. Moreover, any numerical or alphabetical ranges provided herein are intended to include both the upper and lower value of those ranges. In addition, any listing or grouping is intended, at least in one embodiment, to represent a shorthand or convenient manner of listing independent embodiments; as such, each member of the list should be considered a separate embodiment.

What is claimed is:

1. A clip-on accessory for a pair of eyeglasses comprising:
a frame, constructed to asymmetrically integrate two eye lens components, incorporating a clip retainer that reversibly affixes the frame to a pair of eyeglasses of a wearer;
an occlusion eye lens component integrated on one side of the frame designed and positioned for full occlusion of a first lateral retina of the first eye of the wearer, wherein the occlusion eye lens component is positioned from about the lateral-medial retina division line of the first eye of the wearer to about the inner corner of the eye of the wearer; and
a tinted eye lens component integrated on the other side of the frame positioned for view by the entire retina of the second eye of the wearer,
wherein the occlusion lens component and the tinted eye lens component are integrated asymmetrically in the frame.

2. The clip-on accessory of claim 1, wherein the clip retainer is structured to rotate roughly 180 degrees.

3. The clip-on accessory of claim 1, wherein the clip retainer is invertible to position the occlusion eye lens component on the left or the right side of the wearer.

4. A pair of eyeglasses comprising:
an eyeglasses frame-front securing two lenses, wherein the frame-front is connected with a bridge and terminating in two temples, constructed to asymmetrically integrate an occlusion eye lens component and a tinted eye lens component;
an occlusion eye lens component integrated on one side of the frame designed and positioned for full occlusion of a first lateral retina of the first eye of the wearer, wherein the occlusion eye lens component is positioned from about the lateral-medial retina division line of the first eye of the wearer to about the inner corner of the eye of the wearer; and
a tinted eye lens component integrated on the other side of the frame positioned for view by the entire retina of the second eye of the wearer,
wherein the occlusion lens component and the tinted eye lens component are integrated asymmetrically in the frame.

5. The pair of eyeglasses of claim 4, wherein the tinted eye lens component is one of the two lenses secured in the eyeglasses frame-front.

6. The pair of eyeglasses of claim 4, wherein the frame-front comprises a full rim, a half rim, or is rimless.

7. The pair of eyeglasses of claim 4, wherein the bridge is a regular bridge, a keyhole bridge, or metal bridge.

8. The pair of eyeglasses of claim 4, wherein at least one of the two lenses is for correcting vision.

9. The pair of eyeglasses of any one of claim 4, wherein the two lenses are not for correcting vision.

10. The pair of eyeglasses of claim 4, wherein the occlusion eye lens component is formed as part of an amalgamated lens that is equal in total size to the tinted eye lens component and comprises an area of occlusion positioned from about the lateral-medial retina division line of the first eye of the wearer to about the inner corner of the eye of the wearer, wherein the remainder of the amalgamated lens is clear or tinted.

11. The pair of eyeglasses of claim 4, wherein the pair of eyeglasses is invertible.

12. A method for treatment of a brain disorder characterized by neurologic or psychiatric disorder symptomology with a lateralized difference in hemispheric emotional valence, comprising:
identifying a patient with a brain disorder;
measuring a left hemispheric emotional valence for a left hemisphere of a brain of the patient and a right hemispheric emotional valence for a right hemisphere of the brain of the patient to identify a patient with a lateralized difference in hemispheric emotional valence;
determining which hemisphere of the brain of the patient with a lateralized difference in hemispheric emotional valence has a more positive valence, and which hemisphere of the brain has a more negative valence; and
applying to the patient
a clip-on accessory for a pair of eyeglasses comprising:
a frame, constructed to asymmetrically integrate two eye lens components, incorporating a clip retainer that reversibly affixes the frame to a pair of eyeglasses of a wearer:
an occlusion eye lens component integrated on one side of the frame designed and positioned for full occlusion of a first lateral retina of the first eye of the wearer, wherein the occlusion eye lens component is positioned from about the lateral-medial retina division line of the first eye of the wearer to about the inner corner of the eye of the wearer; and
a tinted eye lens component integrated on the other side of the frame positioned for view by the entire retina of the second eye of the wearer,
wherein the occlusion lens component and the tinted eye lens component are integrated asymmetrically in the frame or
a pair of eyeglasses comprising:
an eyeglasses frame-front securing two lenses, wherein the frame-front is connected with a bridge and terminating in two temples, constructed to asymmetrically integrate an occlusion eye lens component and a tinted eye lens component;
an occlusion eye lens component integrated on one side of the frame designed and positioned for full occlusion of a first lateral retina of the first eye of the wearer, wherein the occlusion eye lens component is positioned from about the lateral-medial retina division line of the first eye of the wearer to about the inner corner of the eye of the wearer; and
a tinted eye lens component integrated on the other side of the frame positioned for view by the entire retina of the second eye of the wearer,
wherein the occlusion lens component and the tinted eye lens component are integrated asymmetrically in the frame, wherein the occlusion eye lens component is formed as part of an amalgamated lens that is equal in total size to the tinted eye lens component and comprises an area of occlusion positioned from about the lateral-medial retina division line of the first eye of the wearer to about the inner corner of the eye of the wearer, wherein the remainder of the amalgamated lens is clear or tinted,
wherein the occlusion lens component is designed and positioned for full occlusion of the lateral retina associated with the hemisphere of the brain with the more negative valence combined with differential stimulation of the opposing retina,
such that the brain disorder with lateralized difference in hemispheric emotional valence is treated in said patient.

13. The method for treatment of claim 12, wherein the brain disorder may be selected from the group consisting of depression, attention deficit disorder, schizophrenia, bipolar disorder, anxiety disorders, substance abuse disorders such as alcohol abuse and drug abuse, eating disorders such as anorexia and bulimia, phobias, Asperser's syndrome, dissociative disorders, insomnia, borderline personality disorder, general well-being, Alzheimer's Disease, Parkinson's Disease, Autism, Stroke and any combinations thereof.

14. The method for treatment of claim 13, wherein the brain disorder includes one of persistent anxiety, anxiety attacks, feelings of panic, fears of social contacts, obsessive-compulsive disorder, phobias, post-traumatic stress disorder, or generalized anxiety disorder.

15. A method for stimulating a change in the psychological state of a subject, comprising the steps of:
determining which hemisphere of the brain of a subject with a lateralized difference in hemispheric emotional valence has a more positive valence and which has a more negative valence;
applying to the subject
one or more clip-on accessories comprising:
a frame, constructed to asymmetrically integrate two eye lens components, incorporating a clip retainer that reversibly affixes the frame to a pair of eyeglasses of a wearer:
an occlusion eye lens component integrated on one side of the frame designed and positioned for full occlusion of a first lateral retina of the first eye of the wearer, wherein the occlusion eye lens component is positioned from about the lateral-medial retina division line of the first eye of the wearer to about the inner corner of the eye of the wearer; and
a tinted eye lens component integrated on the other side of the frame positioned for view by the entire retina of the second eye of the wearer,
wherein the occlusion lens component and the tinted eye lens component are integrated asymmetrically in the frame or
one or more pairs of eyeglasses comprising:
an eyeglasses frame-front securing two lenses, wherein the frame-front is connected with a bridge and terminating in two temples, constructed to asymmetrically integrate an occlusion eye lens component and a tinted eye lens component;
an occlusion eye lens component integrated on one side of the frame designed and positioned for full occlusion of a first lateral retina of the first eye of the wearer, wherein the occlusion eye lens component is positioned from about the lateral-medial retina division line of the first eye of the wearer to about the inner corner of the eye of the wearer; and
a tinted eye lens component integrated on the other side of the frame positioned for view by the entire retina of the second eye of the wearer
wherein the occlusion lens component and the tinted eye lens component are integrated asymmetrically in the frame, wherein the occlusion eye lens component is formed as part of an amalgamated lens that is equal in total size to the tinted eye lens component and comprises an area of occlusion positioned from about the lateral-medial retina division line of the first eye of the wearer to about the inner corner of the eye of the wearer, wherein the remainder of the amalgamated lens is clear or tinted,
wherein the occlusion lens component is designed and positioned for full occlusion of the lateral retina associated with the hemisphere of the brain with the more negative valence combined with differential stimulation of the opposing retina; and
such that the full occlusion of lateral retina associated with the hemisphere of the brain with the more negative valence combined with differential stimulation of the opposing retina provides favorable change in the psychological state of the subject.

16. The method of claim 15, wherein the determination of the lateralized difference in hemispheric emotional valence with the more positive valence and with the more negative valence comprises the steps of:
providing the first clip-on accessory or the first-pair of eyeglasses to the subject, wherein the occlusion lens component is designed and positioned for full occlusion of the lateral retina of the left hemisphere and differential stimulation of the retina of the opposing retina;
assessing the change in the psychological state of the subject of the occlusion and differential stimulation of the first clip-on accessory for a pair of eyeglasses or a first pair of eyeglasses;
providing a second clip-on accessory or a second pair of eyeglasses to the subject, wherein the occlusion lens component is designed and positioned for full occlusion of the lateral retina of the right hemisphere and differential stimulation of the retina of the opposing retina;
assessing the change in the psychological state of the subject of the occlusion and differential stimulation of the second clip-on accessory for a pair of eyeglasses or a second pair of eyeglasses; and
comparing the first and second clip-on accessory for a pair of eyeglasses or pair of eyeglasses, to determine which hemisphere of the brain of a subject with a lateralized difference in hemispheric emotional valence has a more positive valence and which has a more negative valence, wherein the glasses that produce the more favorable change in psychological state determine the more negative valence associated with the lateral retina over which the occlusion lens component is designed and positioned for full occlusion.

17. The method of claim 15, wherein the change in the psychological state of the subject includes a change of psychological symptoms displayed by the subject.

18. The method of claim 15, wherein the change in the psychological state of the subject includes a change in the well-being of the subject.

19. The method of claim 18, wherein the change in the well-being of the subject provides an enhancement in a sport.

20. The method of claim 19, wherein the sport is selected from the group consisting of baseball, golf, basketball, tennis, pickle ball, equestrian, cycling, skating, bowling, boxing, fencing, gymnastics, cricket, volleyball, hockey, table tennis, football, badminton, archery, soccer, running, weightlifting, and lacrosse.
